(19) United States
(12) Patent Application Publication
(10) Pub. No.: US 2004/0153446 A1
(43) Pub. Date: Aug. 5, 2004

(54) Review and navigation in hierarchical database views

(76) Inventor: Michael J. Castronova, Carmel, NY (US)

Correspondence Address: Michael J. Castronova, 75 Sparrow Ridge Road, Carmel, NY, 10512, US

(21) Appl. No.: 10/655,254

(22) Filed: Sep. 4, 2003

Related U.S. Application Data
(60) Provisional application No. 60/408,223, filed on Sep. 4, 2002.

(51) Int. Cl. G06F 7/00

(52) U.S. Cl. 707/3

(57) ABSTRACT

A computer method for viewing and navigating hierarchically organized data in a display that clearly delineates between the set of previous choices and the set of current choices. At any point in the navigational process, the display contains two navigation controls that are separated by a white space. The primary navigation control consists of a selectable list that contains the nodes that lie along the path to the last node visited (the set of previous choices). The secondary navigation control consists of a selectable list that contains the children of this node (the set of current choices). Choices that were not made and choices that could not be made are not shown. The user can independently review the set of previous choices by scrolling up or down the primary navigation control. The user can independently review the set of current choices by scrolling up or down the secondary navigation control. Where the display is small and vertically orientated (such as the Dell Axim X5 Pocket PC) the two navigation controls are arranged vertically, relative to each other. Where the display is small and horizontally orientated (such as the Nokia 9210 Communicator) the two navigation controls are arranged horizontally, relative to each other. Where the display is large enough to accommodate either arrangement (such as a desktop computer), the user may dynamically select either the vertical or horizontal arrangement of the two navigation controls.

### CROSS-REFERENCE TO RELATED APPLICATIONS

This application claims the benefits of Provisional Patent Application Ser. No. 60/408/223 filed 2002 Sep 4.

### FEDERALLY SPONSORED RESEARCH

Not Applicable

### SEQUENCE LISTING OR PROGRAM

(See enclosed CD-ROM)

### BACKGROUND OF THE INVENTION

1. Field of the Invention

This invention relates to a computer method for viewing and navigating a hierarchically organized database.

2. Description of the Prior Art

As will be appreciated by those skilled in the art, data items have a hierarchical arrangement when a data element can be regarded as below or belonging to another data item that is at a higher level. The set of choices the user has made while navigating down the data hierarchy are commonly referred to as the set of previous choices. The set of choices that lie immediately below the most recent choice are commonly referred to as the set of current choices.

Computer programs that provide for the review, navigation and management of hierarchically organized data are each well known and widely used. However, when focus is placed specifically on the review and navigational aspects of current programs, it is discovered that they lack the clarity to make the review and navigational experience simple enough for inexperienced users. Note that I am discussing how the data is viewed and navigated, not how the data is entered or structured within the database.

A prior art technique for navigating through hierarchically-organized database views concatenates the nodes that make up the set of previous choices 18 to the nodes that make up the set of current choices 20 (FIG. 2). The result is a contiguous string of selectable choices. This result generates the undesirable side effect of blurring the distinction between the two sets of data. To reduce this blurring effect, shading is used to highlight the set of previous choices 18. This shading, however, does not eliminate the blurring that occurs when two data sets are concatenated together into an unbroken string of contiguous choices. An example of this kind of system can be found in U.S. Pat. No. 6,154,750 to Roberge et al.

### BACKGROUND OF INVENTION—OBJECTS AND ADVANTAGES

An object of the present invention is to display hierarchically organized data in a way that naturally conforms to the display layouts of various devices. For instance, some handheld devices use a vertical screen orientation 32 (FIG. 3) similar to the Dell Axim X5 Pocket PC. Other handheld devices use a horizontal screen orientation 34 (FIG. 8) similar to the Nokia 9210 Communicator.

In order to accommodate various screen layouts the present invention displays the set of previous choices 18 and the set of current choices 20 in separate controls (FIG. 3). The set of previous choices 18 is displayed in the primary navigation control 22. The set of current choices 20 is displayed in the secondary navigation control 24. Then, by separating these two controls with a white space 26 (approximately 1/4 inch in width), the present invention is able to position the two data sets in a vertical arrangement 28 (FIG. 3) and a horizontal arrangement 30 (FIG. 8).

For a desktop computer with a large display screen 36 (FIG. 9) the present invention allows users to dynamically change the arrangement of the two controls between a vertical arrangement 28 (in a vertical screen orientation 32) and a horizontal arrangement 30 (in a horizontal screen orientation 34). This leads to ergonomic advantages. It accommodates any personal preference a user may have regarding the arrangement of the two controls. Allowing the user to dynamically change between vertical and horizontal arrangements may also reduce any fatigue encountered during long sessions at the display.

Another object of the present invention is to make it easier for inexperienced users to determine where the set of previous choices ends and the set of current choices begins. By displaying the two data sets in separate navigational controls and by clearly separating these two controls with a white space, the present invention makes it easy for even the most inexperienced user to determine where the set of previous choices ends and the set of current choices begins.

Yet another object of the present invention is to provide the user with the ability to scroll through either set of data without affecting the display of the other data set. This is accomplished by displaying each set of data in a separate, selectable list control. The user is able to scroll through the entire set the previous choices without disturbing the nodes that make up the set of current choices. The user is able to scroll through the entire set of current choices without disturbing the nodes that make up the set of previous choices.

### SUMMARY

Conceptually, the set of previous choices 18 and the set of current choices 20 are separate but related data sets (FIG. 3). By displaying each set in its own independently navigated control and by clearly separating the controls with a white space 26, the present invention presents the user with a view of the data that more clearly adheres to this concept of separate but related data sets.

### DRAWINGS—FIGURES

FIG. 1 is a schematic diagram of the hierarchically organized database used to illustrate this invention. The following selections from FIG. 1 are used in FIGS. 2-7 to illustrate movement through the hierarchy: Sports 10, Football 12, NFL 14, and Teams 16.

FIG. 2 is a schematic diagram of a computer screen showing how the prior art technique might look while navigating the selections indicated in FIG. 1.

FIG. 3 is a schematic diagram of a computer screen showing how the present invention might look while navigating the selections indicated in FIG. 1 on a small, handheld device with a vertical screen orientation 32 such as a Dell Axim X5 Pocket PC.

FIGS. 4 and 5 are schematic diagrams of a computer screen showing how the present invention might be used to navigate down the hierarchy.

FIGS. 6 and 7 are schematic diagrams of a computer screen showing how the present invention might be used to navigate up the hierarchy.

FIG. 8 is a schematic diagram of a computer screen showing how the present invention might look on a small handheld device with a horizontal screen orientation 34 such as a Nokia 9210 Communicator.

FIG. 9 is a schematic diagram of a large display screen 36 showing how the present invention might appear on a desktop computer in both a vertical screen orientation 32 and a horizontal screen orientation 34.

### DRAWINGS—REFERENCE NUMERALS

10 Sports

12 Football

14 NFL

16 Teams

18 set of previous choices

20 set of current choices

22 primary navigation control

24 secondary navigation control

26 a white space

28 vertical arrangement

30 horizontal arrangement

32 vertical screen orientation

34 horizontal screen orientation

36 large display screen

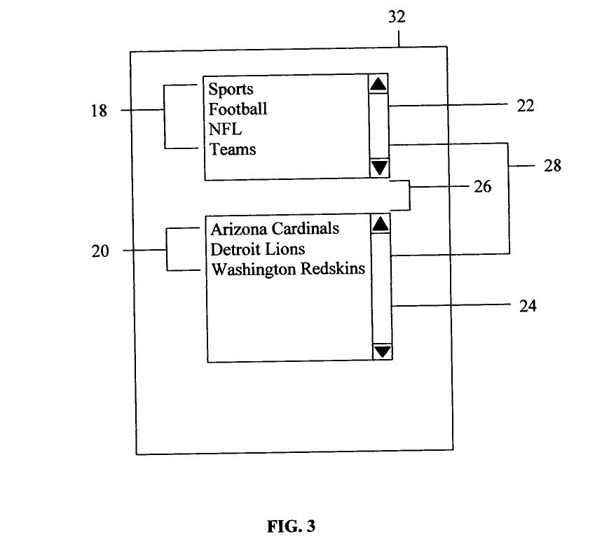

### DETAILED DESCRIPTION—FIG. 3-PREFERRED EMBODIMENT OF THE INVENTION

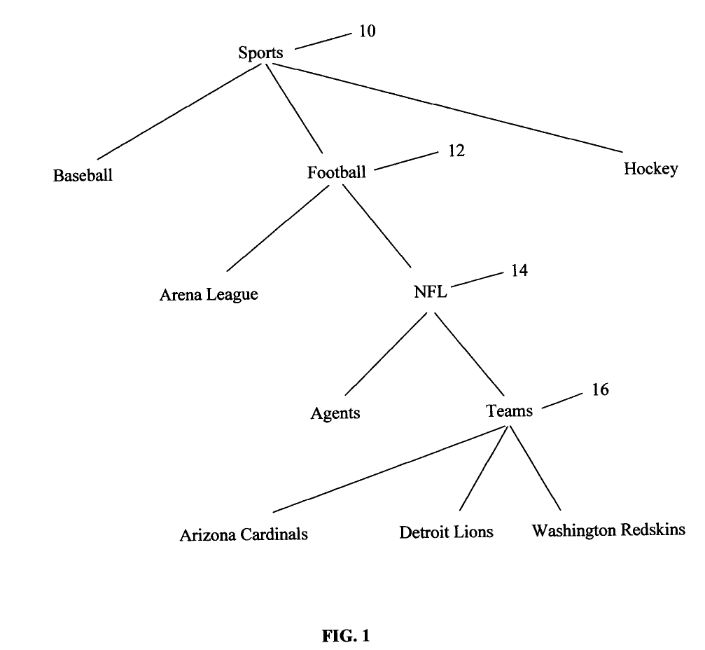

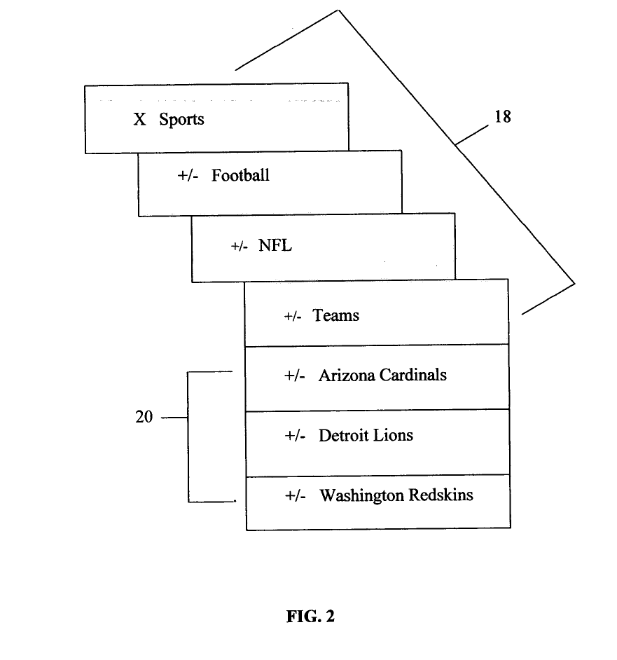

In presenting a detailed description of a preferred embodiment of the invention, I will make use of examples based on a simple hierarchical outline (FIG. 1). These examples are provided to illustrate certain elements of the invention. They are not to be construed as limiting the invention in any way.

FIG. 3 is a screen representation of the current invention as it looks on a small device with a vertical screen orientation 32 such as the Dell Axim X5 Pocket PC. The primary navigation control 22; the secondary navigation control 24, and a white space 26 that separates them are shown in a vertical arrangement 28.

The primary navigation control 22 is a selectable list. It allows the user to select a single node from the set of previous choices 18. It also allows the user to scroll up and down through the entire set of previous choices 18 without affecting the display of the set of current choices 20. The secondary navigation control 24 is a selectable list. It allows the user to select a single node from the set of current choices 20. It also allows the user to scroll up and down through the entire set of current choices 20 without affecting the display of the set of previous choices 18. Scrolling up either selectable list is accomplished by tapping or clicking the up arrow in the upper right corner of the selectable list. Scrolling down either selectable list is accomplished by tapping or clicking the down arrow in the lower right corner of the selectable list.

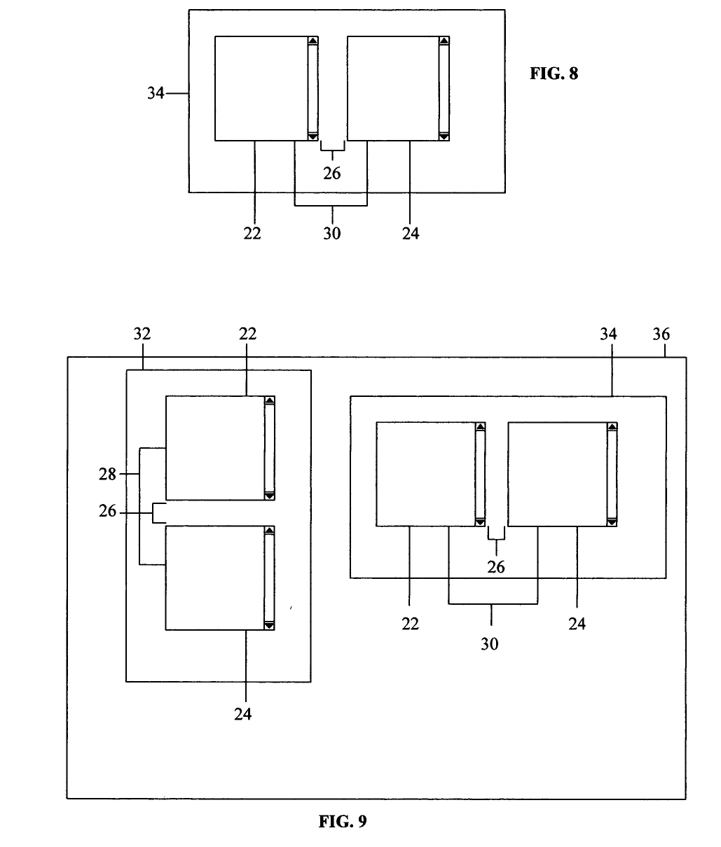

FIGS. 8-9—Alternative Embodiments

There are various possibilities with regard to the relative screen orientations of devices.

FIG. 8 is a screen representation of the current invention as it might look on a small device with a horizontal screen orientation 34 such as the Nokia 9210 Communicator. The primary navigation control 22 and the secondary navigation control 24 are positioned in a horizontal arrangement 30 with a white space 26 separating them. This white space 26 provides a clear separation between the primary navigation control 22 and the secondary navigation control 24.

FIG. 9 is a screen representation of the current invention as it might look on a desktop computer with a large display screen 36. Where the display is large, the user may dynamically select either the vertical screen orientation 32 or the horizontal screen orientation 34 of the current invention. In both cases, the primary navigation control 22 and the secondary navigation control 24 are clearly separated by a white space 26. The user may select either arrangement through the use of a menu option or other selection methodology. The method used for making the selection is not central to the invention and no reference to it is made in this drawing.

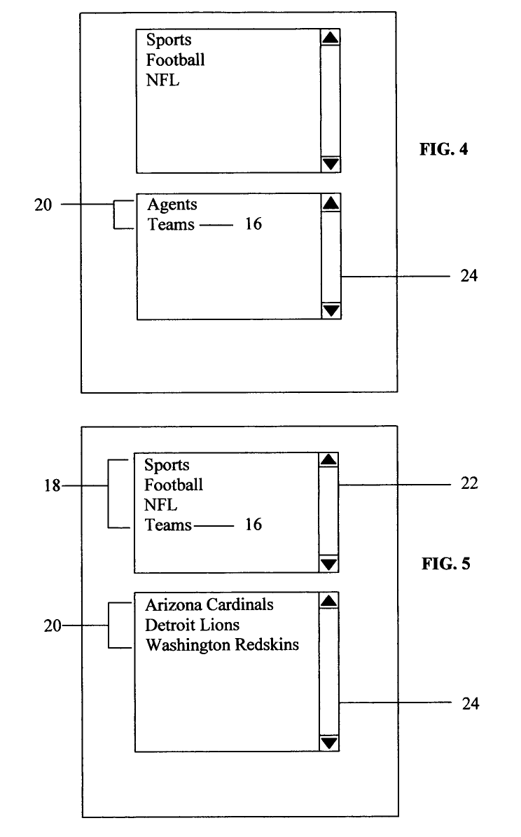

Operation—FIGS. 4, 5, 6, 7

FIG. 4 is a screen representation showing the user initiating the action of navigating down the data hierarchy. Here, the user selects the node Teams 16 from the set of current choices 20 in the secondary navigation control 24.

FIG. 5 is a screen representation showing the result of the action taken in FIG. 4. Only the selected node Teams 16 and its parent nodes are displayed as selectable nodes in the set of previous choices 18 in the primary navigation control 22. The set of current choices 20 (for the selected node) are then displayed in the secondary navigation control 24.

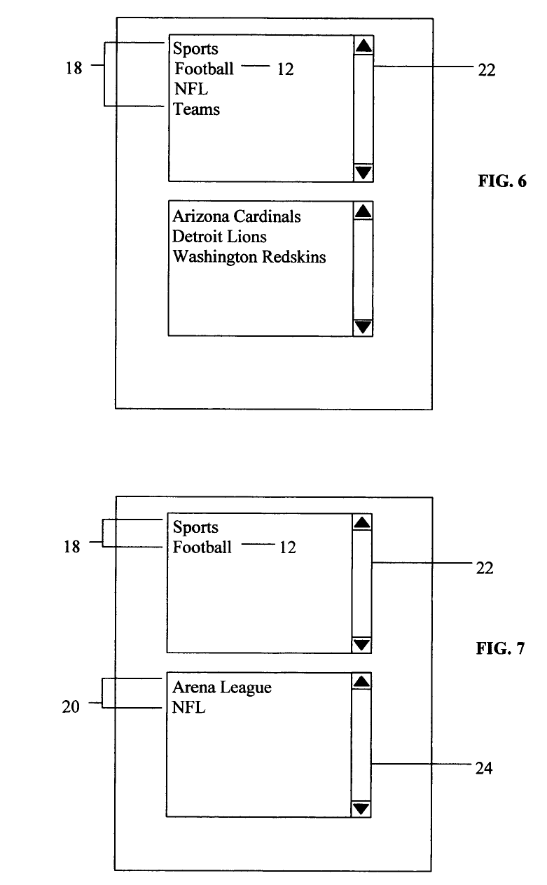

FIG. 6 is a screen representation showing the user initiating the action of navigating up the data hierarchy. Here, the user selects the node Football 12 from the set of previous choices 18 in the primary navigation control 22.

FIG. 7 is a screen representation showing the result of the action taken in FIG. 6. Only the selected node Football 12 and its parent nodes are displayed in the primary navigation control 22. The set of current choices 20 (for the selected node) are then displayed in the secondary navigation control 24.

While the invention has been described in terms of a single preferred embodiment and two alternative embodiments, those skilled in the art will recognize that the invention can be practiced with modification within the spirit and scope of the appended claims.

I claim:

1. A computer method for viewing and navigating data in a hierarchically organized database comprising:
(a) a primary navigation control consisting of a selectable list;
(b) a secondary navigation control consisting of a selectable list;
(c) displaying said primary navigation control and said secondary navigation control in a manner whereby said primary navigation control is separated from said secondary navigation control by a white space;
(d) displaying the hierarchically organized database, said database having a root node, said root node having at least one child node, and also having further descendant nodes;
(e) displaying said root node in said primary navigation control;
(f) displaying each of said child nodes in said secondary navigation control;
(g) navigating said database by selecting a single node from said primary navigation control or from said secondary navigation control;
(h) retaining the display of only said selected node and the parent nodes of said selected node by displaying said selected node and said parent nodes as selectable nodes in said primary navigation control, and displaying the child nodes associated with said selected node as selectable child nodes in said secondary navigation control;
(i) repetitively navigating down said database by selecting only one of said child nodes in said secondary navigation control;
(j) repetitively navigating up said database by selecting only one of said nodes in said primary navigation control.
